(19) United States
(12) Patent Application Publication
(10) Pub. No.: US 2022/0346408 A1
(43) Pub. Date: Nov. 3, 2022

(54) USE OF A COMPOSITION FOR REDUCING THE MOISTURE AND NITROGEN CONTENT IN POULTRY FECES

(71) Applicant: Alzchem Trostberg GmbH, Trostberg (DE)

(72) Inventor: Jürgen SANS, Trostberg (DE)

(73) Assignee: Alzchem Trostberg GmbH, Trostberg (DE)

(21) Appl. No.: 17/619,793

(22) PCT Filed: Jun. 25, 2020
(86) PCT No.: PCT/EP2020/067847

§ 371 Date: Dec. 16, 2021

(30) Foreign Application Priority Data
Jul. 26, 2019 (DE) 10 2019 120 249.3

(51) Int. Cl. A23K 20/142; A23K 50/75; A23K 20/105

(52) U.S. Cl. CPC A23K 20/142; A23K 50/75; A23K 20/105

(57) ABSTRACT

The present invention concerns the use of a composition containing guanidino acetic acid and glycine for reducing the moisture in poultry feces and/or for reducing the nitrogen content in poultry feces.

The present invention concerns the use of a composition containing guanidino acetic acid and glycine for reducing the moisture in poultry feces and/or for reducing the nitrogen content in poultry feces.

In the husbandry of farm animals, feces of varying type occur. In contrast to mammals whose feces occur in two different types, namely in liquid and in solid-pasty form (urine and feces in the narrower sense), in birds there are no completely liquid excretions. A urine of low water content is eliminated together with the feces from the so-called cloaca in the form of solid-pasty feces. Depending on the conditions of husbandry, the feces may be mixed with litter.

One problem with animal husbandry is the large quantities of feces which must be disposed of and for which disposal costs may be incurred [Landbauforschung-vTI Agriculture and Forestry Research, Special Issue 322 (2008), www.topagrar.com/ . . . /Home-top-News-Die-Guelle-Kosten-explodieren-1122110]. Here transport costs are another important influencing factor.

Another problem is the prohibition on the spreading of feces during the winter period, which is officially prescribed in many states [https://www.landwirtschafts-kammer.de/landwirtschaft/ackerbau/duengung/quelle/verordnung/sperrfrist.htm]. This imposes requirements for the size of manure storage sites.

Furthermore, odour nuisances occur which cause problems during storage, transport and application of liquid manure [https://www.lwk-niedersachsen.de/index.cfm/portal/6/nav/348/article/21682.html]. These phenomena may be countered by using the following methods or devices:
A) Manure separators, mainly used in pig and cattle farming, which lead to a separation into a liquid part and a solid part. The two phases are then further treated separately. The solid phase may be composted or dried and utilised thermally. For thermal utilisation, special combustion furnaces are described (EP 2249080 A1). The liquid phase is spread onto agricultural areas or may be further concentrated.
B) Liquid manure is vaporised and the escaping ammonia is captured and may be sold commercially, for example in the form of ammonium sulphate.
C) DE 102010033251 A1 describes a method in which liquid manure is converted into ammonium carbonate, solid fertiliser and domestic/drinking water.
D) Liquid manure and poultry excrement may be fermented in biogas plants (WO 2013/152266 A2, EP 1589095 B1)
E) Special methods and devices for drying hen droppings are described (DE 19851793 A1).

The disadvantage of all these methods is the great complexity and cost of equipment for processing the feces. The generation of feces at the point of occurrence is not reduced.

Another problem in animal husbandry is the emission of environmentally-relevant pollutant gases such as ammonia, methane and carbon dioxide (CO₂) from the feces. Ammonia is here formed by the decomposition of nitrogen-containing compounds, e.g. amino acids, which largely originate from the animal feed and are not completely utilised in the body of the animal. Typical nitrogen levels, also referred to below as the N content of feces, are shown in Table 1.

TABLE 1
Average nitrogen content of feces from animal husbandry according to
the North Rhine Westphalia Department of Agriculture, issue 2014

| | Dry substance [%] | Total nitrogen [kg/t] |
|---|---|---|
| Cattle manure | 23 | 5.6 |
| Goose droppings | 30 | 8 |
| Turkey droppings | 50 | 19.1 |
| Hen & chicken droppings I | 30 | 18.1 |
| Hen & chicken droppings II | 60 | 29.9 |
| Fresh chicken dung | 28 | 17 |
| Dry chicken dung | 50 | 25.5 |
| Dairy cow & cattle manure I | 6 | 3.2 |
| Dairy cow & cattle manure II | 10 | 4.5 |
| Fattening pig manure I | 3 | 4.3 |
| Fattening pig manure II | 7 | 6.5 |

The values were taken from various farms. The great fluctuations in hen & chicken droppings, dairy cow & cattle manure, and fattening pig manure, result from the different feeding and husbandry conditions.

In 2014 in Germany, 740,000 tonnes of ammonia were emitted. The maximum quantity of 550,000 tonnes ammonia set by the Economic Commission for Europe, UNECE, for 2010 was thus far exceeded. Up to 95% of the ammonia emissions are caused by agriculture (http://www.umweltbundesamt.de/daten/luftbelastung/luftschadstoff-emissionen-in-deutschland/ammoniak-emissionen#textpart-1). Half the emissions result from the spreading of organic fertilisers such as dung or liquid manure (https://www.lwk-niedersachsen.de/index.cfm/portal/6/nav/348/article/21682.html).

Because of the conversion of ammonia into nitrous oxide, which has a greenhouse effect almost 300 times higher than that of carbon dioxide (CO₂) and a mean retention time in nature of 114 years, the emission of ammonia constitutes a serious climate problem. Possible technical measures for reducing the emission of ammonia from feces are:
A) low-emission spreading of feces
B) direct working of feces into the soil
C) covering feces storage sites
D) spreading of feces with nitrification inhibitors.

The disadvantage of the above-mentioned methods is that the measures taken are only applied at the end and do not reduce the nitrogen content (N content) in the feces.

Another problem of the nitrogen content in feces is the legislatively implemented regulations on the maximum permitted quantity of nitrogen per field area. Nitrogen from all types of manure is included. Since, in modern agriculture, the feed producers are not often also meat producers, the meat producer often does not have sufficient field area for spreading the excrements of the animals. As a result, it costs money to have feces collected. Feces, which should actually have a value because of the nitrogen content, have a negative market value because of the legal regulations. Another disadvantage of nitrogen compounds in the feces is that the nitrogen is bonded in various ways, and is released either too quickly or too slowly for the plants. Poultry feces contain large quantities of nitrogen in the form of uric acid. This may mean that the nitrogen in the feces is included in the permitted nitrogen quantity, but the nitrogen cannot be utilised by the plants.

In connection with the occurrence or accumulation of feces, there is also the problem that if the husbandry conditions are too wet, e.g. from the use of wet litter, inflammation of the birds' skin is observed. The birds' growth may also be adversely affected (M. F. Martland, Avian Pathology, 14 (1985) 353-364; Ulcerative Dermatitis in Broiler Chickens: The Effect of Wet Litter; M. F. Martland, Avian Pathology, 13 (1984) 241-252; Wet Litter as a Cause of Plantar Pododermatitis Leading to Foot Ulceration and Lameness in Fattening Turkeys).

Overly liquid feces in the shed may also lead to wetness in the birds' accommodation area. Liquid feces can occur even in healthy animals. A change of shed, change of feed, increased external temperatures and green feed are examples of causes of more liquid feces.

Another disadvantage of excessively moist bird droppings is the poorer mechanical processing. Mechanical cleaning of the sheds with wet droppings is more complex than with dry droppings, since wet droppings adhere and are more difficult to remove from walls and floors, and problems also result when unloading from transporters.

According to the prior art, there are various possible solutions for reducing the moisture in the birds' accommodation area. The aim is to ensure that, with a high stocking density, the harmful effects of feces on the animals are avoided or at least largely reduced, disposal costs are kept low, shed cleaning is easier and feces can be transported well:
A) Mainly dry litter is used
B) Litter is removed and replaced regularly
C) Partially or fully gapped floors, which are regularly cleaned and disinfected, are used in the husbandry of cattle and pigs. Liquid excrement can easily run out of the gapped floor.
D) In ground rearing of chickens, in part of the shed a manure board or manure bunker may be used for removing bird excrement.
E) In cage rearing of chickens, the manure falls through the grated floor and can no longer be reached by the birds.
F) The addition of bentonite to the feed inter alia reduces the moisture in the dung [e.g. J. H. Quisenberry, Clays and Clay Minerals, 1968, Vol. 16, 267-270]

The disadvantage with the methods according to the prior art is that the methods used are labour-intensive, and it is not the actual moisture in the dung which is reduced but merely the probability of contact with the damp dung. The minimum quantity of introduced litter must be adapted to the expected quantity of moisture. With less moisture, less litter may be used, and thereby both the costs for litter and the costs for disposal of the litter after use can also be reduced. The above-mentioned methods are therefore only partially effective and only achieve a reduction in the possibilities of contact with damp dung. The disadvantage of cage rearing is that this is not a species-appropriate keeping. Also, cage rearing is or will be prohibited in more and more countries. The disadvantage of method F is that bentonite must be added in large quantities (percent range).

The present invention is based on the object of improving the quality of poultry excrement which occurs at the point of production during rearing, husbandry or fattening of poultry. Furthermore, the moisture in the dung shall be reduced in order to reduce inflammation and diseases in the birds. Furthermore, the quality of poultry excrement shall be modified so as to alleviate the disposal problems closely linked to the production of feces, relieve the load on excrement storage sites in terms of quantity, moisture and ammonia emission, and reduce the negative environmental influences with respect to ammonia emissions from animal husbandry.

This object is achieved by a use according to claim 1. Preferred embodiments of the invention are given in the subclaims which may optionally be combined with each other.

Thus subject of the present invention is the use of a composition containing guanidino acetic acid and glycine to reduce the moisture in poultry feces and/or to reduce the nitrogen content in poultry feces, during rearing, husbandry or fattening of the poultry.

In this use during rearing, husbandry or fattening of the poultry, it is essential to the invention that a composition is used containing guanidino acetic acid and glycine. The composition may be used as a solid preparation in a feed or dissolved in water as a drink solution. The feed or drink solution are provided to the poultry for normal nutrition.

Guanidino acetic acid (CAS No. 352-97-6, sum formula C₃H₇N₃O₂-also referred to below as GAA), and also known as glycocyamine, N-amidinoglycine, N-(aminoimino-methyl)-glycine, has been available commercially for some time and has approval for use as a feed additive in fattening poultry. Many studies have shown, inter alia, that the use of guanidino acetic acid during rearing, husbandry or fattening of poultry leads to a saving in feed, an improvement in feed consumption and/or an increase in fattening effect.

Glycine (syn. glycol, amino acetic acid, amino-ethane acid; C₂H₅NO₂, CAS no. 56-40-6) has approval for use as a foodstuff additive E640 in the EU with no quantity restrictions, and has also been available commercially as a feed additive for a long time and has approval for use in poultry fattening. Studies on chickens [Corzo A.; Kidd, M. T. (2004) Dietary Glycine needs of broiler chicks, Poult. Sci. 83(8), 1382-4)] have shown that glycine is a limiting nutrient, although it is also produced in the animal itself. It has been found [Graber, G.; Baker, D. H. (1973) The essential nature of glycine and proline for growing chicks, Poult. Sci. 52, 892-896)], that the birds themselves produce only 60-70% of the amount required for optimum growth.

In contrast to creatine, guanidino acetic acid and its salts have a significantly higher stability in acidic watery solution, and are only converted into creatine under physiological conditions. Guanidino acetic acid is here converted into creatine only after resorption, in particular in the liver. Thus in contrast to creatine, the majority of the guanidino acetic acid administered or supplied in feed is not decomposed by instability reactions, e.g. in the stomach, and eliminated before resorption, but is actually available for the corresponding physiological metabolic reactions.

Surprisingly, it has been found that the administration of a composition containing guanidino acetic acid and glycine leads to the desired benefits, namely the reduction of moisture in the feces and the reduction of the content of nitrogen-containing compounds in the feces. This also applies if both water and the feed composition necessary for normal nutrition or fattening are provided in a quantity which exceeds the bird's daily needs. Thus the birds can grow normally or at increased rate, wherein at the same time the quality of the feces is improved. Without being bound by theory, it is an assumption that the guanidino acetic acid and the glycine have a positive influence on the activity of the bird's digestive organs, so that both moisture in the feces and the content of nitrogen-containing compounds in the feces are reduced in comparison with feces of poultry which have received a feed composition without guanidino acetic acid and glycine. In particular, thus the amount of litter can also be reduced, whereby less storage volume is required for the storage of feces and lower transport costs are incurred for disposal.

With the supplement of guanidino acetic acid and glycine, in comparison with feeding with the same base feed without the addition of guanidino acetic acid and glycine, the moisture content, i.e. the water content in the feces, is preferably reduced by at least 3.5%, more preferably by at least 4%, even more preferably by at least 5%, particularly preferably by at least 6%, furthermore preferably by at least 8%, and most preferably by at least 10%.

Also, completely surprisingly, it was found that when feed is supplemented with guanidino acetic acid and glycine, the nitrogen content in the feces is reduced although the birds consume as much water and feed as their instinct allows and their digestive tracts can process.

With the feed supplement according to the invention with guanidino acetic acid and glycine, in comparison with feeding with the same base feed without the addition of guanidino acetic acid and glycine, the nitrogen content in the feces is reduced by preferably at least 5%, more preferably by at least 6% and even more preferably by at least 7%.

Preferably, a composition may be used which contains guanidino acetic acid and glycine, wherein the weight ratio of guanidino acetic acid to glycine lies in the range from 1:1 to 100:1, preferably 1:1 to 10:1, further preferably 1.5:1 to 10:1, further preferably 2:1 to 8:1 and preferably 2:1 to 6:1.

According to a preferred embodiment of the invention, it may be provided that the use is such that the composition is provided as a solid preparation in a feed for the birds. Further preferably, the composition is provided as a solid preparation in a feed for the birds, wherein the feed contains a base feed, guanidino acetic acid in a quantity from 0.1 to 5 g per 1 kg base feed, and glycine in a quantity from 0.01 to 2.5 g per 1 kg base feed.

Here, further preferably, the feed may contain the guanidino acetic acid in a quantity of at least 0.2 g, preferably at least 0.3 g, further preferably at least 0.4 g per 1 kg base feed. Furthermore, preferably, the feed may contain the guanidino acetic acid in a quantity of maximum 5 g, further preferably maximum 4 g, further preferably maximum 3 g and particularly preferably maximum 2.5 g per 1 kg base feed.

In a further preferred embodiment, the feed contains the guanidino acetic acid preferably in a quantity from 0.01 g to 1 g, even more preferably in a quantity from 0.1 g to 1 g per 1 kg base feed.

Here, furthermore preferably, the feed contains glycine in a quantity of at least 0.02 g, preferably at least 0.03 g, further preferably at least 0.04 g per 1 kg base feed. Furthermore, preferably, the feed may contain glycine in a quantity of maximum 2.5 g, further preferably maximum 2 g, further preferably maximum 1 g and particularly preferably maximum 0.6 g per 1 kg base feed.

Thus a use is particularly preferred in which the composition is provided as a solid preparation in a feed for the poultry, wherein the feed contains a base feed, guanidino acetic acid in a quantity from 0.1 to 5 g per 1 kg base feed, and glycine in a quantity from 0.01 to 2.5 g per 1 kg base feed.

Particularly preferably, a composition is used which consists of guanidino acetic acid and glycine.

According to a further embodiment, the composition may also be provided as a watery solution in the form of a drink solution for the poultry. Thus also a further object of the present invention is the use of a composition containing guanidino acetic acid and glycine for reducing the moisture in poultry feces and/or reducing the nitrogen content in poultry feces during rearing, husbandry or fattening of the poultry, wherein the composition is provided as a drink solution for the poultry and wherein the drink solution preferably contains water, guanidino acetic acid in a quantity from 0.05 to 1.2 g, in particular 0.4 to 1.2 g, or further preferably from 0.1 to 0.3 g per 1 l water, and glycine in a quantity from 0.005 g to 0.12 g, in particular 0.04 to 0.12 g, per 1 l water.

The concentration of the watery solution may vary depending on the size, age and/or weight of the birds. Preferably, the solution comprises a concentration of guanidino acetic acid in water of at least 0.05 g/l, further preferably at least 0.1 g/l, and—simultaneously or independently thereof—further preferably maximum 1.2 g/l, further preferably maximum 1 g/l, further preferably maximum 0.8 g/l, further preferably maximum 0.6 g/l, particularly preferably maximum 0.5 g/l, particularly preferably maximum 0.4 g/l and quite particularly preferably maximum 0.3 g/l.

Further preferably, the solution comprises a concentration of glycine in water of at least 0.005 g/l, further preferably at least 0.01 g per 1 l water, and—simultaneously or independently thereof—further preferably maximum 0.12 g per 1 l water, further preferably maximum 0.1 g per 1 l water, particularly preferably maximum 0.05 g per 1 l water.

Preferably, the solution comprises a concentration of guanidino acetic acid in water of 0.1 to 0.8 g/l, particularly preferably from 0.1 to 0.5 g/l and quite particularly preferably from 0.1 to 0.3 g/l, and a concentration of glycine in water from 0.01 to 0.08 g/l, particularly preferably from 0.01 to 0.05 g/l, and quite particularly preferably from 0.01 to 0.03 g/l.

Quite particularly preferably, here the feed or drink solution is provided to the poultry ad libitum for the nourishment of the poultry.

In connection with the present invention, the term ad libitum means a quantity of feed and a quantity of drink solution which exceeds the daily nutritional need for feed and drink solution of each individual bird concerned, or which, with respect to the entirety of individuals concerned, exceeds the daily nutritional need of the entirety of individuals. Thus according to the present invention, the feed or drink solution is preferably provided “ad libitum”, namely in surplus quantities for free consumption by the poultry.

Thus the preferred use ad libitum differs significantly from a specific administration of an active substance, which for example is administered daily in the form of a defined quantity of 500 mg per day in single doses and independently of further nutrition or foodstuffs. It is all the more surprising that the mere provision ad libitum, namely at the free disposal of the poultry, of a feed containing a base feed, guanidino acetic acid in a quantity from 0.1 to 5 g per 1 kg feed and glycine in a quantity from 0.01 to 2.5 g per 1 kg feed, or the provision ad libitum, namely at the free disposal of the poultry, of a drink solution containing water, guanidino acetic acid in a quantity from 0.05 to 1.2 g per 1 l water and glycine in a quantity from 0.005 to 0.12 g glycine per 1 l water, leads to the desired success, namely a reduction in the moisture in the poultry feces and/or a reduction in the nitrogen content in the poultry feces.

It has been found that the use according to the invention of the guanidino acetic acid in combination with glycine is not restricted to the substances as such. Rather, it has been found that in the use, both guanidino acetic acid as such, namely as a free acid, or also as a salt of guanidino acetic acid may be used.

Thus a use according to the present invention is preferred in which the composition contains
i) guanidino acetic acid as a free acid or in the form of a salt of this acid, and/or
ii) glycine as a free acid or in the form of a salt of this acid.

Particularly preferably, as a salt, a salt may be selected from the group of alkali or earth alkali salts of guanidino acetic acid. Quite particularly preferred here are sodium guanidino acetate, potassium guanidino acetate, magnesium guanidino acetate or calcium guanidino acetate.

It has furthermore been found that in the use, both glycine as such, namely as a free acid, or also in the form of a salt of glycine may be used. Particularly preferably, the salt may be selected from the group of alkali or earth alkali salts of glycine, in particular sodium glycinate, potassium glycinate, magnesium glycinate or calcium glycinate.

The invention described herein may be applied to a plurality of various poultry types. Particularly preferably, the composition containing guanidino acetic acid and glycine may be used in poultry selected from the group ducks, geese, chickens, hens, laying hens, broilers, turkey cocks, quail, ostriches and turkey hens.

Furthermore, experiments forming the basis of the invention have shown that the base feed used should have a defined calorific value. Firstly, the base feed should have a calorific value of firstly no less than the calorific value established for normal nutrition and healthy growth, and secondly no more than said calorific value in order to avoid obesity. Good results have been found if the base feed for the poultry has a calorific value from 8 MJ to 20 MJ per 1 kg base feed, in particular from 10 MJ to 15 MJ per 1 kg base feed, and/or the base feed is a balanced base feed according to Animal Nutrition Handbook, 3^{rd} Revision, 2014 Section 12, Poultry Nutrition and Feeding.

Both the method and the use may be particularly preferably implemented in that the base feed comprises at least one grain, a grain meal, a coarse grain or extracts therefrom. Furthermore, here a method or a use is preferred in which at least one grain, a grain meal, coarse grain or extracts therefrom are selected from the group:
a. maize, maize meal, coarse-ground maize or an extract therefrom,
b. millet, millet meal, coarse-ground millet or an extract therefrom,
c. soya, soya meal, coarse-ground soya or an extract therefrom,
d. wheat, wheat meal, coarse-ground wheat or an extract therefrom, and/or
e. barley, barley meal, coarse-ground barley or an extract therefrom.

Furthermore, the use may be particularly preferred if the base feed furthermore contains at least one further feed additive, in particular a further feed additive from the group of mineral substances, amino acids and vitamins. Quite particularly preferably, this feed additive may be selected from the group calcium carbonate, mono- or dicalcium phosphate, lysine, methionine, threonine, tryptophan, valine, arginine and vitamins, and mixtures thereof.

In a particularly preferred embodiment, a base feed is used which itself has no content of guanidino acetic acid and no content of glycine.

A preferred base feed, such as given for example in Table 1a of this application, comprises
150‰ to 200‰, in particular 188‰ wheat,
300‰ to 400‰, in particular 350‰ maize,
150‰ to 200‰, in particular 165‰ soya meal,
50‰ to 70‰, in particular 60‰ sunflower meal,
70‰ to 90‰, in particular 80‰ wheat mixtures,
10‰ to 30‰, in particular 20‰ animal fat,
20‰ to 30‰, in particular 24‰ soya oil,
25‰ to 40‰, in particular 32‰ lime,
60‰ to 70‰, in particular 64‰ grit,
4‰ to 8‰, in particular 6‰ monocalcium phosphate,
2‰ to 3‰, in particular 2.5‰ salt (NaCl),
1‰ to 2‰, in particular 1.6‰ sodium hydrogen carbonate,
0.4‰ to 0.8‰, in particular 0.6‰ L-lysine HCl,
1‰ to 1,5‰, in particular 1.2‰ DL-methionine, and
0.02‰ to 0.05‰, in particular 0.035‰ choline.

Furthermore, the use may be particularly preferred if, as water, drinking water, spring water, well water or tap water is used.

Furthermore, the supplement with the composition containing guanidino acetic acid and glycine may be given permanently over the life of the bird or in selected phases.

The present invention furthermore concerns a method for reducing the moisture in poultry feces and/or for reducing the nitrogen content in poultry feces, wherein a composition containing guanidino acetic acid and glycine is administered to the poultry during rearing, during husbandry or in fattening of the poultry, for consumption ad libitum by the poultry.

The preferred embodiments of the method according to the invention are described for the uses according to the invention.

The present invention furthermore concerns a composition containing guanidino acetic acid and glycine for reducing the moisture in poultry feces and/or for reducing the nitrogen content in poultry feces, in each case during rearing, during husbandry or in fattening of the poultry.

In particular, the invention concerns a composition consisting of guanidino acetic acid and glycine for reducing the moisture in poultry feces and/or for reducing the nitrogen content in poultry feces, in each case during rearing, during husbandry or in fattening of the poultry.

The preferred embodiments of the composition according to the invention are described for the uses according to the invention.

The following examples will illustrate the present invention.

### EXAMPLES

### Feed Composition Used for Test 1

TABLE 1b
Nutrients of feed composition

| | Declared level |
|---|---|
| Nutrients | [g/kg] |
| Dry mass | 890 |
| Raw protein | 161.2 |
| Raw fats | 66.8 |
| Raw fibre | 38.7 |
| Raw ash | 129.7 |
| Lysine | 7.80 |
| Methionine | 3.81 |
| Calcium | 38.1 |
| Phosphorus | 5.2 |
| Sodium | 1.5 |
| Energy (MJ/kg) | 11.79 |

TABLE 1a
Constituents of feed composition

| Composition | ‰ |
|---|---|
| Wheat | 188.04 |
| Maize | 350.00 |
| Soya meal | 165.00 |
| Sunflower meal | 60.00 |
| Wheat mixtures | 80.00 |
| Animal fat (lard) | 20.00 |
| Soya oil | 24.00 |
| Premix | 5.0 |
| Lime (fine) | 32.00 |
| Grit | 64.00 |
| Monocalcium phosphate | 6.00 |
| Salt | 2.50 |
| NaHCO3 | 1.60 |
| L-lysine HCl | 0.60 |
| DL-methionine | 1.20 |
| Sod. phos 5000 G | 0.06 |
| Choline | 0.035 |

### Test 1

192 laying hens (Lohmann LSL Classic, age: 38 weeks) were randomly divided into 4 groups of 48 birds and kept in mesh cases (30×45 cm²) for a period of 4 weeks. Each hen had unrestricted access to two nipple drinks which were topped up with tap water daily (ad libitum). The feed points were also topped up daily (ad libitum). The minimum temperature was 20° C. and the room was illuminated for 14 hours per day and darkened for 10 hours. The excrement from each individual hen was captured in a manure box. The manure boxes were emptied weekly and combined separately for each group. The combined manure from each group was cleaned, mechanically homogenised, and the solids content was determined by drying at 130° C. in a vacuum. The nitrogen content of the dried specimens was determined using the Kjeldahl method.

Group 1 was fed with the above feed (Table 1a, 1b). For Group 2, for each 1000 kg of the above-mentioned feed, 600 g guanidino acetic acid were added to the feed. For Group 3, for each 1000 kg of the above-mentioned feed, 10 g glycine were added to the feed. For Group 4, for each 1000 kg of the above-mentioned feed, 600 g guanidino acetic acid and 10 g glycine were added to the feed.

TABLE 2
Total quantity feces

| | Weight of feces [kg] | | | |
|---|---|---|---|---|
| | Week 1 | Week 2 | Week 3 | Week 4 |
| Group 1 | 12.4 | 13.5 | 12.7 | 12.8 |
| Group 2 | 12.3 | 12.8 | 12.3 | 12.9 |
| Group 3 | 12.7 | 13.0 | 12.8 | 13.3 |
| Group 4 | 11.9 | 12.5 | 12.0 | 12.2 |

TABLE 3
Solids content of feces according to Table 2

| | Solids content of feces [%] | | | |
|---|---|---|---|---|
| | Week 1 | Week 2 | Week 3 | Week 4 |
| Group 1 | 45.2 | 47.6 | 46.1 | 48.7 |
| Group 2 | 48.3 | 51.8 | 51.4 | 50.1 |
| Group 3 | 45.5 | 48.0 | 48.9 | 48.4 |
| Group 4 | 49.8 | 53.1 | 52.5 | 53.9 |

The conversion (100-solids content)%=water content % gives a water content according to Table 4.

TABLE 4
Water content of feces according to Table 2 and Table 3

| | Water content of feces [%] | | | |
|---|---|---|---|---|
| | Week 1 | Week 2 | Week 3 | Week 4 |
| Group 1 | 54.8 | 52.4 | 53.9 | 51.3 |
| Group 2 | 51.7 | 48.2 | 48.6 | 49.9 |
| Group 3 | 54.5 | 52.0 | 51.1 | 51.6 |
| Group 4 | 50.2 | 46.9 | 47.5 | 46.1 |

From this, firstly by subtraction the absolute percentage change in water content relative to Group 1 (Δ_{abs}) was calculated, and the relative percentage change in water content relative to Group 1 (Δᵣₑₗ). The results are shown in Table 5.

TABLE 5
Absolute and relative change in water content of feces
according to Table 4

| | Week 1 | Week 2 | Week 3 | Week 4 |
|---|---|---|---|---|
| Δ_{abs} (Group 1-Group 2) [%] | 3.1 | 4.2 | 5.3 | 1.4 |
| Δ_{abs} (Group 1-Group 3) [%] | 0.3 | 0.4 | 2.8 | −0.3 |
| Δ_{abs} (Group 1-Group 4) [%] | 4.6 | 5.5 | 6.4 | 5.2 |
| Δᵣₑₗ (Group 1-Group 2) [%] | 5.6 | 8.0 | 9.8 | 2.7 |
| Δᵣₑₗ (Group 1-Group 3) [%] | 0.5 | 0.7 | 5.2 | −0.6 |
| Δᵣₑₗ (Group 1-Group 4) [%] | 8.4 | 10.5 | 11.9 | 10.1 |

In Group 4, supplemented with guanidino acetic acid and glycine, there is an increased solids content in the feces in comparison with Group 1. The water content in the faces fell by between 8.4% and 11.9%. In the group supplemented with guanidino acetic acid alone (Group 2), the effect on the water content was weaker, and in the group supplemented with glycine alone (Group 3), there was almost no effect on the water content.

The nitrogen content of the dried specimens was determined using the Kjeldahl method and is shown in Table 6.

TABLE 6
Nitrogen content of feces according to Table 2 and Table 3

| | Nitrogen (N) in dried feces [kg/t] | | | |
|---|---|---|---|---|
| | Week 1 | Week 2 | Week 3 | Week 4 |
| Group 1 | 52.3 | 55.2 | 51.9 | 52.4 |
| Group 2 | 50.4 | 52.8 | 51.7 | 50.1 |
| Group 3 | 50.9 | 53.2 | 53.7 | 52.0 |
| Group 4 | 49.0 | 50.4 | 47.8 | 48.2 |

From the values in Table 6, firstly by subtraction the absolute change in nitrogen content relative to Group 1 (ΔN_{abs}) was calculated, and from this the relative percentage change in nitrogen content relative to Group 1 (ΔNᵣₑₗ). The results are shown in Table 7.

TABLE 7
Absolute and relative change in nitrogen content of feces
according to Table 6

| | Week 1 | Week 2 | Week 3 | Week 4 |
|---|---|---|---|---|
| ΔN_{abs} (Group 1-Group 2) [kg/t] | 1.9 | 2.4 | 0.2 | 2.1 |
| ΔN_{abs} (Group 1-Group 3) [kg/t] | 1.4 | 2.0 | −1.8 | 0.4 |
| ΔN_{abs} (Group 1-Group 4) [kg/t] | 3.3 | 4.8 | 4.1 | 4.2 |
| ΔNᵣₑₗ (Group 1-Group 2) [%] | 3.6 | 4.3 | 0.3 | 4.0 |
| ΔNᵣₑₗ (Group 1-Group 2) [%] | 2.7 | 3.6 | −3.5 | 0.8 |
| ΔNᵣₑₗ (Group 1-Group 4) [%] | 6.3 | 8.7 | 7.9 | 8.0 |

In Group 4, supplemented with guanidino acetic acid and glycine, the nitrogen content in the feces was lower in comparison with Group 1. The nitrogen content in the feces was 6.3% to 8.7% lower than in the comparison group. In the groups supplemented solely with guanidino acetic acid (Group 2) and solely with glycine (Group 3), there was only a slight effect on the nitrogen content.

### Test 2

2505 fattening chickens (Cobb 400) were accommodated in a density of 94.5 square inches/bird on wood shavings. Water and feed were available ad libitum. In the first 15 days, heating was provided with infrared lamps. All birds were fed for 18 days with a poultry starter diet (based on wheat, coarse-ground soya extract, maize, soya bean toast, maize germ): Gallugold® poultry starter OG (12.2 MJ/kg, 22.00% raw protein, 0.62% methionine, 6.00% raw fat, 3.80% raw fibre, 6.80% raw ash, 0.95% calcium, 0.65% phosphorus, 0.16% sodium; additives per kg: vitamin A 10,000 IU, vitamin D3 5,000 IU, vitamin E 100 mg, copper 10 mg, selenium 0.45 mg). From day 18, the birds were divided at random into 4 groups of 46 birds. Group 1 was fed with Gallugold® poultry grain OG (based on maize, soya bean, wheat, soya bean toast, vegetable oil, maize germ) (12.6 MJ/kg, 22.00% raw protein, 0.56% methionine, 6.8% raw fat, 3.5% raw fibre, 9.0% raw ash, 0.90% calcium, 0.65% phosphorus, 0.15% sodium; additives per kg: vitamin A 13,000 IU., vitamin D3 5,000 IU, vitamin E 100 mg, copper 10 mg, selenium 0.42 mg). Group 2 was fed as Group 1 but 0.06 w.-% guanidino acetic acid was first added to the feed which was then mechanically mixed for 10 min in a drum. Group 3 was fed as Group 1 but 0.002 w.-% glycine was first added to the feed which was then mechanically mixed for 10 min in a drum.

Group 4 was fed as Group 1 but 0.06 w.-% guanidino acetic acid and 0.002 w.-% glycine were first added to the feed which was then mechanically mixed for 10 min in a drum.

On days 21, 25 and 30, each group was transferred for 24 hours to an empty shed with a concrete floor without litter. After 24 h, the groups were transferred back and by means of a collection bin, the feces of each group was collected and the solids content determined by drying at 130° C. in a vacuum. The values are shown in Tables 8 and 9.

TABLE 8
Total quantity of feces

| | Weight of feces [kg] | | |
|---|---|---|---|
| | Day 21 | Day 25 | Day 30 |
| Group 1 | 0.63 | 0.71 | 0.83 |
| Group 2 | 0.60 | 0.69 | 0.81 |
| Group 3 | 0.64 | 0.73 | 0.80 |
| Group 4 | 0.61 | 0.67 | 0.79 |

TABLE 9
Solids content of feces according to Table 8

| | Solids content of feces [%] | | |
|---|---|---|---|
| | Day 21 | Day 25 | Day 30 |
| Group 1 | 29.8 | 31.0 | 30.3 |
| Group 2 | 29.6 | 33.4 | 31.3 |
| Group 3 | 30.2 | 30.5 | 31.1 |
| Group 4 | 32.4 | 33.9 | 32.8 |

The conversion (100-solids content)%=water content % gives a water content according to table 10.

TABLE 10
Water content of feces according to Table 8 and Table 9

| | Water content of feces [%] | | |
|---|---|---|---|
| | Day 21 | Day 25 | Day 30 |
| Group 1 | 70.2 | 69.0 | 69.7 |
| Group 2 | 70.4 | 66.6 | 68.7 |
| Group 3 | 69.8 | 69.5 | 68.9 |
| Group 4 | 67.6 | 66.1 | 67.2 |

From this, firstly by subtraction the absolute percentage change in water content relative to Group 1 (Δ_{abs}) was calculated, and the relative percentage change in water content relative to Group 1 (Δᵣₑₗ). The results are shown in Table 11.

TABLE 11
Absolute and relative change in water content of feces
according to Table 10

| | Day 21 | Day 25 | Day 30 |
|---|---|---|---|
| Δ_{abs} (Group 1-Group 2) [%] | −0.2 | 2.4 | 1.0 |
| Δ_{abs} (Group 1-Group 3) [%] | 0.4 | −0.5 | 0.8 |
| Δ_{abs} (Group 1-Group 4) [%] | 2.6 | 2.9 | 2.5 |
| Δᵣₑₗ (Group 1-Group 2) [%] | −0.3 | 3.5 | 1.4 |
| Δᵣₑₗ (Group 1-Group 3) [%] | 0.6 | −0.7 | 1.1 |
| Δᵣₑₗ (Group 1-Group 4) [%] | 3.7 | 4.2 | 3.6 |

In Group 4, supplemented with guanidino acetic acid and glycine, there was an increased solids content in the feces in comparison with Group 1. The water content of the feces fell by between 3.6% and 4.2%. In Group 2 there was a slight effect. In Group 3 almost no effect was evident.

The nitrogen content of the dried specimens was determined using the Kjeldahl method.

TABLE 12
Nitrogen content of feces according to Table 8 and Table 9

| | Nitrogen (N) in dried feces [kg/t] | | |
|---|---|---|---|
| | Day 21 | Day 25 | Day 30 |
| Group 1 | 58.1 | 59.5 | 58.7 |
| Group 2 | 56.9 | 57.7 | 55.4 |
| Group 3 | 58.3 | 56.7 | 59.2 |
| Group 4 | 54.4 | 55.2 | 54.1 |

TABLE 13
Absolute and relative change in nitrogen content
of feces according to Table 12

| | Day 21 | Day 25 | Day 30 |
|---|---|---|---|
| ΔN_{abs} (Group 1-Group 2) | 1.2 | 1.8 | 3.3 |
| [kg/t] | | | |
| ΔN_{abs} (Group 1-Group 3) | −0.2 | 2.8 | −0.5 |
| [kg/t] | | | |
| ΔN_{abs} (Group 1-Group 4) | 3.7 | 4.3 | 4.6 |
| [kg/t] | | | |
| ΔNᵣₑₗ (Group 1-Group 2) | 2.1 | 3.3 | 5.6 |
| [%] | | | |
| ΔNᵣₑₗ (Group 1-Group 3) | −0.3 | 4.7 | −0.9 |
| [%] | | | |
| ΔNᵣₑₗ (Group 1-Group 4) | 6.4 | 7.2 | 7.8 |
| [%] | | | |

Furthermore, in Group 4 supplemented with guanidino acetic acid and glycine, the nitrogen content in the feces was lower in comparison with Group 1. The nitrogen content in the feces was 6.4% to 7.8% lower than in the comparison group. In Group 2, an effect with respect to lower nitrogen content was also evident, but this was significantly smaller than with Group 4. In Group 2, on Day 21 and on Day 30, there was a slightly higher N content (0.3% and 0.9%) than in the control group.

1. A method for reducing moisture and/or nitrogen content in poultry feces, the method comprising providing a composition containing guanidino acetic acid and glycine to the poultry during rearing, husbandry or in fattening of the poultry.

2. Method according to claim 1, wherein the composition is provided as a solid preparation in a feed for the poultry, and the feed contains a base feed, guanidino acetic acid in a quantity from 0.1 to 5 g per 1 kg base feed and glycine in a quantity from 0.01 to 2.5 g per 1 kg.

3. Method according to claim 1, wherein the composition is provided as a drink solution for the poultry, and the drink solution contains water, guanidino acetic acid in a quantity from 0.05 to 1.2 g per 1 l water and glycine in a quantity from 0.005 g to 0.12 g per 1 l water.

4. Method according to claim 2, wherein the feed or drink solution is provided to the poultry ad libitum for nourishment of the poultry.

5. Method according to claim 1, wherein the composition contains:
i) guanidino acetic acid as a free acid or in the form of a salt of this acid; and/or
ii) glycine as a free acid or in the form of a salt of this acid.

6. Method according to claim 1, wherein the guanidino acetic acid is used in the form of a salt of guanidino acetic acid, wherein the salt is selected from the group consisting of alkali or earth alkali salts of guanidino acetic acid, in particular sodium guanidino acetate, potassium guanidino acetate, magnesium guanidino acetate or calcium guanidino acetate.

7. Method according to claim 1, wherein the glycine is used in the form of a salt of glycine, wherein the salt is selected from the group consisting of alkali or earth alkali salts of glycine, in particular sodium glycinate, potassium glycinate, magnesium glycinate or calcium glycinate.

8. Method according to claim 1, wherein the poultry is selected from the group consisting of ducks, geese, chickens, hens, laying hens, broilers, turkey cocks, quail, ostriches and turkey hens.

9. Method according to claim 1, wherein the base feed has a calorific value from 8 MJ to 20 MJ per 1 kg base feed, and/or the base feed is a balanced base feed according to Animal Nutrition Handbook, 3^{rd} Revision, 2014 Section 12, Poultry Nutrition and Feeding.

10. Method according to claim 1, wherein the base feed comprises:
i) at least one grain, grain meal, coarse grain or extracts thereof; and/or
ii) at least one further feed additive selected from the group consisting of calcium carbonate, dicalcium phosphate, amino acids or vitamins.

11. Method for reducing the moisture in poultry feces and/or for reducing the nitrogen content in poultry faeces, wherein a composition containing guanidino acetic acid and glycine is provided for the poultry during rearing, during husbandry or in fattening of the poultry, for consumption ad libitum by the poultry.
